(19) United States
(12) Patent Application Publication
(10) Pub. No.: US 2023/0186342 A1
(43) Pub. Date: Jun. 15, 2023

(54) BUNDLE CLICKING SIMULATION TO VALIDATE A/B TESTING BANDIT STRATEGIES

(71) Applicant: SAP SE, Walldorf (DE)

(72) Inventors: Lei Ding, Chengdu (CN); Yangyang Chen, Chengdu (CN)

(21) Appl. No.: 17/547,637

(22) Filed: Dec. 10, 2021

(51) Int. Cl. G06Q 30/02; G06K 9/62

(52) U.S. Cl. CPC G06Q 30/0243; G06K 9/6256

(57) ABSTRACT

Embodiments are associated with user behavior simulation. A user behavior simulation apparatus may retrieve, from a unit data store, relevant unit data. The simulation apparatus may also retrieve, from a user behavior data store, user behavior data (and train a user interest decay model based on the retrieved user behavior data) along with a unit bundle generation strategy model from a unit bundle generation strategy data store (and initialize control parameters of the unit bundle generation strategy model). The system may then initialize control parameters of an A/B treatment generation strategy model and repeatedly simulate user interest in unit bundles using the relevant unit data, the user interest decay model, the unit bundle generation strategy model, and the A/B treatment generation strategy model. Based on the simulated user interest in unit bundles, statistics associated with bandit strategy results are collected and transmitted when at least one evaluation condition is satisfied.

### TECHNICAL FIELD

Some embodiments generally relate to methods and systems for use with computer devices, including networked computing devices. More particularly, some embodiments relate to the use of bundle clicking simulation to validate A/B testing bandit strategies.

### BACKGROUND

An enterprise may offer units to users. For example, an online merchant might offer products, or bundles of products (e.g., a basketball, t-shirt, and sneakers) to potential customers. It is to be expected that one particular unit might be more popular with users as compared to another unit. To determine if that is the case, an enterprise may use “A/B testing” to compare user responses to different units. As used herein, the phrase “A/B testing” (also referred to as bucket testing or split-run testing) may refer to a simple randomized controlled experiment, in which two samples (A and B) of a single vector-variable are compared. A/B tests are useful to help understand user engagement and satisfaction of online features like a new feature or product bundle. For example, an e-commerce website purchase funnel may undergo A/B testing (because even a small decrease in drop-off rates can represent significant sales gains). Note that to determine statistical significance, a certain number of test may need to be performed.

However, an enterprise might not want to offer an unpopular unit to a large number of users (e.g., a merchant may lose potential customers if A/B trials of a new product bundle fail to interest a large number of customers). Instead, the enterprise may estimate a unit's effectiveness with minimal user interaction time. To do so, various “bandit strategies” are used to select and evaluate units that are shown to users. As used herein, the phrase “bandit strategy” (also known as a multi-arm strategy or N-armed bandit problem) may refer to a situation in which a fixed, limited set of resources are allocated between competing (alternative) choices in a way that maximizes an expected gain (when each choice's properties are only partially known at the time of allocation and is better understood as time passes). A bandit strategy is a reinforcement learning problem that exemplifies the tradeoff between exploration and exploitation. The multi-armed bandit problem also falls into the broad category of stochastic scheduling.

Thus, it would be desirable to improve the performance of bandit strategies without needing to show units to a substantial number of real-world users.

### SUMMARY OF THE INVENTION

According to some embodiments, systems, methods, apparatus, computer program code and means are provided to accurately and/or automatically improve the performance of bandit strategies (without needing to show units to a substantial number of users) in a way that provides fast and useful results and that allows for flexibility and effectiveness when reacting to those results.

Some embodiments are directed to user behavior simulation. A user behavior simulation apparatus may retrieve, from a unit data store, relevant unit data. The simulation apparatus may also retrieve, from a user behavior data store, user behavior data (and train a user interest decay model based on the retrieved user behavior data) along with a unit bundle generation strategy model from a unit bundle generation strategy data store (and initialize control parameters of the unit bundle generation strategy model). The system may then initialize control parameters of an A/B treatment generation strategy model and repeatedly simulate user interest in unit bundles using the relevant unit data, the user interest decay model, the unit bundle generation strategy model, and the A/B treatment generation strategy model. Based on the simulated user interest in unit bundles, statistics or results associated with the bandit strategy are collected and transmitted when at least one evaluation condition is satisfied.

Some embodiments comprise: means for retrieving, by a computer processor of a user behavior simulation apparatus, relevant unit data from a unit data store; means for training a user interest decay model based on user data retrieved from a user behavior data store; means for initializing control parameters of a unit bundle generation strategy model retrieved from a unit bundle generation strategy data store; means for initializing control parameters of an A/B treatment generation strategy model; means for repeatedly simulating user interest in unit bundles using the relevant unit data, the user interest decay model, the unit bundle generation strategy model, and the A/B treatment generation strategy model; based on the simulated user interest in unit bundles, means for collecting statistics (or results) associated with a bandit strategy; and means for transmitting the collected statistics when at least one evaluation condition is satisfied.

In some embodiments, a communication device associated with a back-end application computer server exchanges information with remote devices in connection with an interactive graphical user simulation interface. The information may be exchanged, for example, via public and/or proprietary communication networks.

A technical effect of some embodiments of the invention is an improved and computerized way to accurately and/or automatically improve the performance of bandit strategies (without needing to show units to a substantial number of users) in a way that provides fast and useful results. With these and other advantages and features that will become hereinafter apparent, a more complete understanding of the nature of the invention can be obtained by referring to the following detailed description and to the drawings appended hereto.

### BRIEF DESCRIPTION OF DRAWINGS

The present disclosure is illustrated by way of example and not limitation in the following figures.

FIG. 1 illustrates A/B testing.

FIG. 2 illustrates bandit strategies.

FIG. 3 is a high-level block diagram of a user simulation system in accordance with some embodiments.

FIG. 4 illustrates a user simulation method according to some embodiments.

FIG. 5 is a user simulation system in a multi-tenant cloud computing environment in accordance with some embodiments.

FIG. 6 is a user simulation method according to some embodiments.

FIG. 7 is a human machine interface result statistics display in accordance with some embodiments.

FIG. 8 is a human machine interface operator or administrator display in accordance with some embodiments.

FIGS. 9A and 9B illustrate Epsilon-Greedy test results for an A/B sorted bundle according to some embodiments.

FIGS. 10A and 10B illustrate Softmax test results for an A/B sorted bundle in accordance with some embodiments.

FIGS. 11A and 11B illustrate UCB test results for an A/B sorted bundle according to some embodiments.

FIG. 12 is an apparatus or platform according to some embodiments.

FIG. 13 illustrates a statistics collection database in accordance with some embodiments.

FIG. 14 illustrates a handheld tablet computer according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components, and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

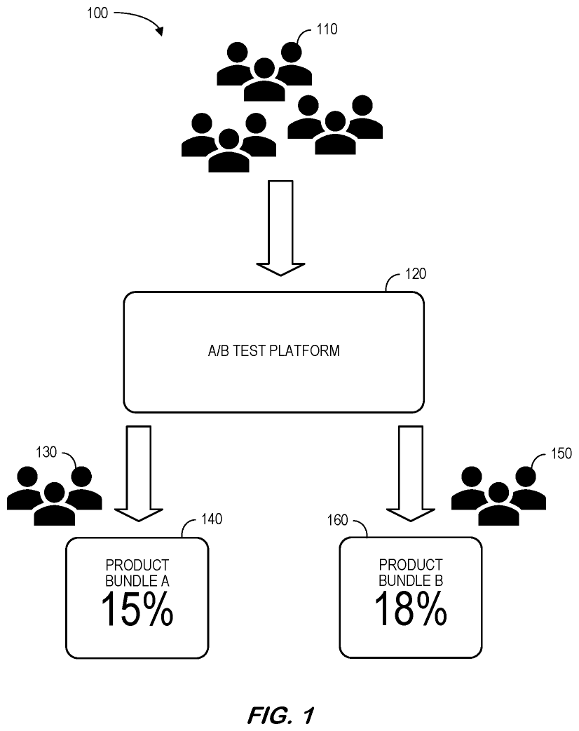

An enterprise may offer an online marketplace as a Software-as-a-Service (“SaaS”) commerce solution that helps a direct-to-consumer brand create an integrated digital commerce experience. The solution may reach potential customers across in-store and digital channels, including mobile, social, iOS, Android application, web applications, etc. Moreover, the marketplace may use intelligent, targeted, and dynamic merchandising to create experiences that are relevant for shoppers and profitable for brands. For example, embedded Artificial Intelligence (“AI”) driven recommendations suggest various product bundles that might be of interest to potential customers. SAP® Upscale Commerce is one example of such a marketplace with an AI-enabled backend system designed for A/B testing to help understand if new features (such as new product bundles) will improve sales. FIG. 1 illustrates 100 A/B testing. An A/B test platform 120 randomly divides a group of users 110 (e.g., potential customers) into a first subset of users 130 and a second subset of users 150. The first subset of users 130 is presented with product bundle A 140 while the second subset of users 150 is presented with product bundled B 160. The success rates of the two product bundles 140, 160 can then be compared. A/B testing is a statistically sound technique to compare two different variants (version A and version B to determine whether the mean value in one test result distribution is actually different than the mean value of the other test result distribution (or is the apparent difference instead just due to chance?). To accurately make such a determination with a particular level of confidence, however, a minimum number of trials need to be performed.

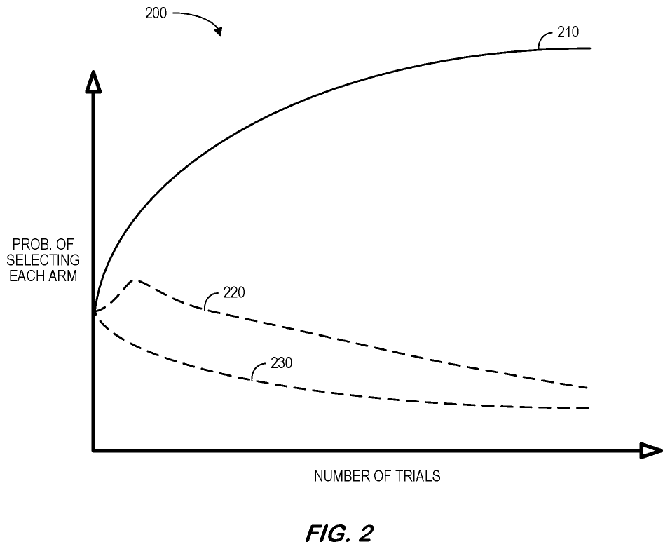

However, an obvious drawback to A/B testing is that merchants will lose potential income if trials of a new product bundle fail to fulfill customer interest for an extended period of time. Therefore, the ability to estimate product bundle effectiveness with minimal interaction time with customers can play an important role in business success (especially for a brand-new feature or product bundle introduction). FIG. 2 illustrates 200 bandit strategies for three different units or product bundles. A graph shows the probability of selecting each bundle (or “arm”) versus the number of trials that have been performed. Here, the algorithm determines that a first product bundle seems to be performing much better than a second 210 that the first product bundle will be presented to potential customers as compared to the other two product bundles 220, 230 (illustrated with dashed lines in FIG. 2).

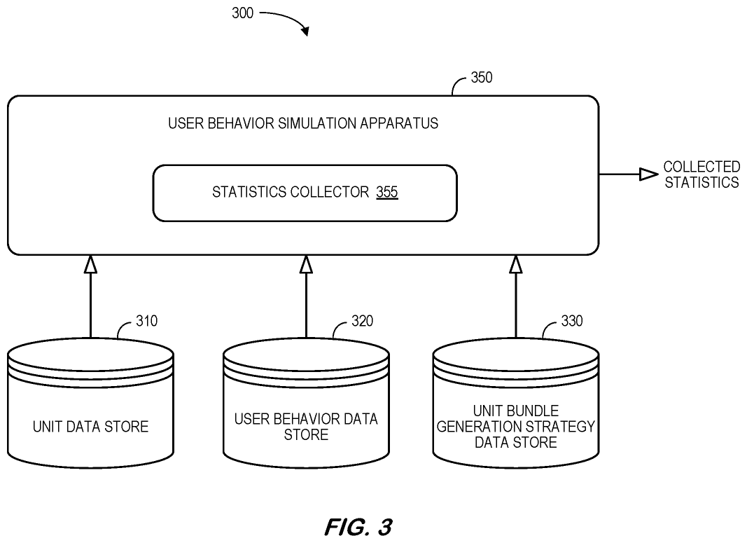

To further improve the use of bandit strategies, according to some embodiments, a system may simulate user reactions to product bundles (instead of presenting the bundles to real users). For example, FIG. 3 is a high-level block diagram of a system 300 according to some embodiments. A unit data store 310, a user behavior data store 320, and a unit bundle generation strategy data store 330 are coupled to a user behavior simulation apparatus 350. The user behavior simulation apparatus 350 may then automatically use a simulation collector 355 to gather and output the results of user simulations. A used herein, the term “automatically” may refer to a device or process that can operate with little or no human interaction.

According to some embodiments, devices, including those associated with the system 300 and any other device described herein, may exchange data via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The elements of the system 300 may store data into and/or retrieve data from various data stores (e.g., the unit data store 310), which may be locally stored or reside remote from the user behavior simulation apparatus 350. Although a single user behavior simulation apparatus 350 is shown in FIG. 3, any number of such devices may be included. Moreover, various devices described herein might be combined according to embodiments of the present invention. For example, in some embodiments, the unit data store 310 and user behavior simulation apparatus 350 might comprise a single apparatus. Some or all of the system 300 functions may be performed by a constellation of networked apparatuses, such as in a distributed processing or cloud-based architecture.

A cloud operator or administrator may access the system 300 via a remote device (e.g., a Personal Computer (“PC”), tablet, or smartphone) to view data about and/or manage operational data in accordance with any of the embodiments described herein. In some cases, an interactive graphical user interface display may let an operator or administrator define and/or adjust certain parameters (e.g., to set up or adjust various user simulation or bandit algorithm values) and/or receive automatically generated statistics, recommendations, results, and/or alerts from the system 300.

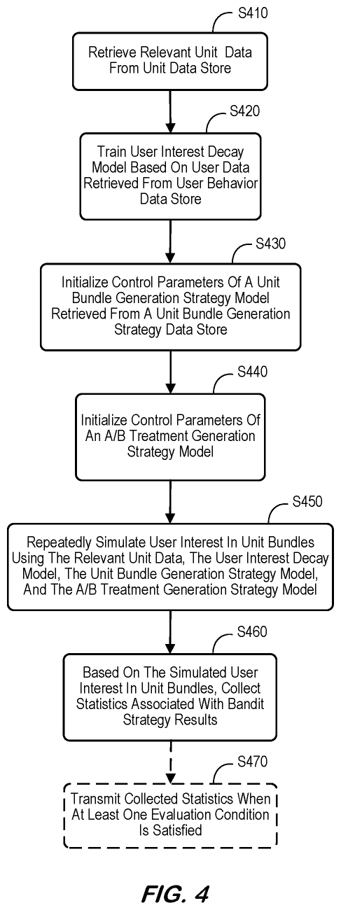

FIG. 4 illustrates a user simulation method according to some embodiments. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S410, a computer processor of a user behavior simulation apparatus may retrieve relevant unit data from a unit data store. According to some embodiments, a “unit” is associated with a product bundle and a user is associated with a simulated potential customer. At S420, the system may train a user interest decay model based on user data retrieved from a user behavior data store. The user behavior data might be associated with, for example, product reviews, product searches, requests for product details, products placed into a virtual shopping cart, product purchases, review-reject statistics, etc.

At S430, control parameters of a unit bundle generation strategy model (retrieved from a unit bundle generation strategy data store) are initialized. The A/B treatment generation strategy model might be associated with, for example, product splitting by category, a campaign-based strategy, etc. At S440, control parameters of an A/B treatment generation strategy model are initialized. According to some embodiments, the relevant unit data, the user behavior data, the unit bundle generation strategy model, and the A/B treatment generation strategy model are associated with a tenant of a multi-tenant cloud computing environment.

At S450, the system may repeatedly simulate user interest in unit bundles using the relevant unit data, the user interest decay model, the unit bundle generation strategy model, and the A/B treatment generation strategy model. Based on the simulated user interest in unit bundles, at S460 statistics or results associated with a bandit strategy are collected. Note that in various embodiments, the user behavior simulation apparatus might be associated with an Epsilon-Greedy bandit simulation, a Softmax bandit simulation, an Upper Confidence Bound (“UCB”) bandit simulation, etc. Moreover, the collected statistics might be associated with a reward convergence, a recommendation trend of the A/B treatment generation strategy model, etc.

At S470, the collected statistics may optionally be transmitted when at least one evaluation condition is satisfied (illustrated with a dashed line in FIG. 4). The evaluation condition might be associated with a number of trials or steps, a reward probability convergence, a splitting probability, a profitability goal, etc. In some embodiments, responsive to the transmitted statistics, product bundles can be automatically deployed or displayed to actual customers.

In this way, dynamic bundle for products may comprise an AI-driven functionality to generate products combinations meet customer requirements while maximizing profit (as well as avoiding unnecessary warehouse storage). Furthermore, when deciding how to interact with customers, one or more Bandit strategies may be used to change the product bundles that are shown to customers. It may therefore need to be determined which Bandit strategy will best improve a merchant's profit. To do so, embodiments may use a simulator that mimics actual (live) customer behaviors and quickly evaluates the effectiveness of Bandit strategies. The simulator may successfully analyze key customer behaviors, adjust data generation distribution, and introduce a natural interest-decay mechanism. With only a few short customer interactions with products, the system may obtain the minimal convergence time of new product (when customer behaviors become almost constant) and a more accurate profit estimation can be reached. With such a statistic, merchants and system administrators can decide whether further calibration of products in an A/B testing group is required.

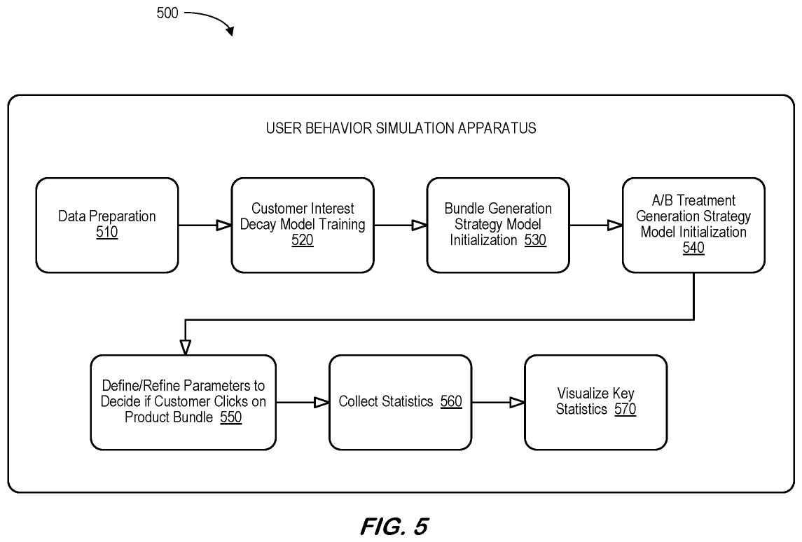

FIG. 5 is a user simulation system 500 in a multi-tenant cloud computing environment in accordance with some embodiments. The system 500 includes data preparation 510 to:
export relevant product data for a specific tenant;
export customer behavior data (statistics about product reviews, additions to a virtual shopping cart, checkout operations, review-reject data, etc.) for the specific tenant;
export bundle generation strategy for the specific tenant; and
export A/B treatment generation strategy for a specific tenant.
   The phrase “A/B treatment” may refer to how products have been grouped into variant A and variant B. Note that various strategies might be used, such as product splitting by categories, campaigns-based strategies, etc.

At 520, the system may train a customer interest decay model by importing customer behavior data. At 530, the system may initialize control parameters of a bundle generation strategy model and then initialize control parameters of an A/B treatment generation strategy model at 540. The system can then define and/or refine parameters used to decide whether a customer will click on a product bundle at 550. At 560, the simulator is run to collect statistics. The system can then visualize key statistics at 570, such as reward convergence, recommendation trend of A/B treatment, etc. As used herein, the phrase “reward convergence” may refer to when a treatment A/B has kept constantly achieved clicking and/or choosing by customers. Moreover, the phrase “recommendation trend of A/B treatment” may refer to which treatment (with what probability) will be proposed by the system.

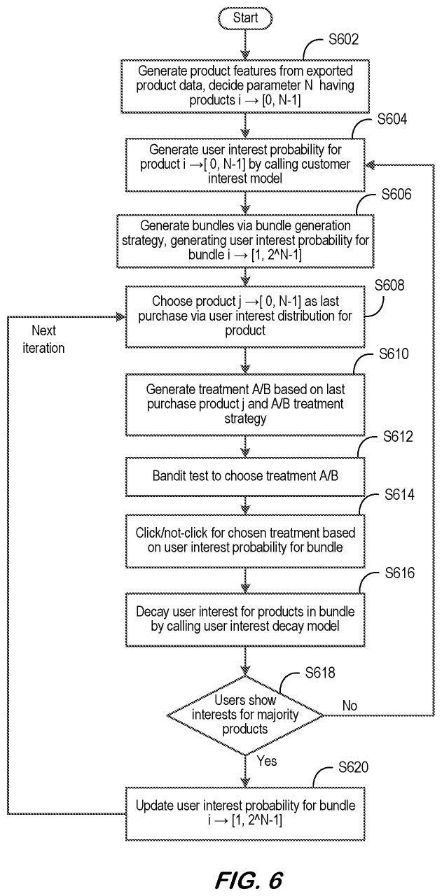

FIG. 6 is a user simulation method 600 according to some embodiments where simulated bundle clicking is used to validate Bandit strategies in AB testing. At S602, product features are generated based on exported product data. The system may concatenate unified product price into a [0,1], 1-vectored product image feature, 1-vector keywords of product. That is, exported product data may be used to decide parameter N having products i→[0, N−1]. To reduce memory consumption, zero-started product indexes have been generated for product representation. At S604, the system generates a customer representation to interact with a bundle application. A pre-trained customer interest model may be called and used to generate user interest probability for each product that has been produced and linked with each customer (probability for product i→[0, N−1]).

At S606, the system may generate bundles via a pre-trained bundle generation strategy model. Based on user interest probability for each product, a customer interest probability is calculated for each bundle: i E [1, 2^{N-1}]. Note that the system may enumerate all possible product combination for N products. Given that each product can be included or excluded in a bundle, the total combination number is 2^{N}. [1, 2′¹] is therefore used as the bundle identifier (since 0 is not actually a bundle at all).

At S608, the system chooses one product as the last purchase via a user interest distribution for a product. This is, product j→[0, N−1] is chosen. At 610, the system generates a treatment A/B based on the last purchased product and a pre-trained A/B treatment strategy model. At 612, bandit testing is performed to adjust what treatment A/B is shown to customer. The system may then generate the customer behavior (e.g., “click” or “not click”) based on the user interest probability for a bundle via a pre-trained customer behavior model at S614. At S616, the system decays user interest for products in bundles by calling a user interest decay model. If users do not show interest for a majority of products in a bundle (larger than a threshold) at 618, the process repeats at S604 (to refine customer interest). If users do show interest for a majority of products in a bundle at 618, the system updates the user interest probability for each bundle i E [1, 2^{N-1}] and T=t+1. If an upper boundary of iterations is reached, the process ends. Otherwise, the process repeats at S608 for the next iteration.

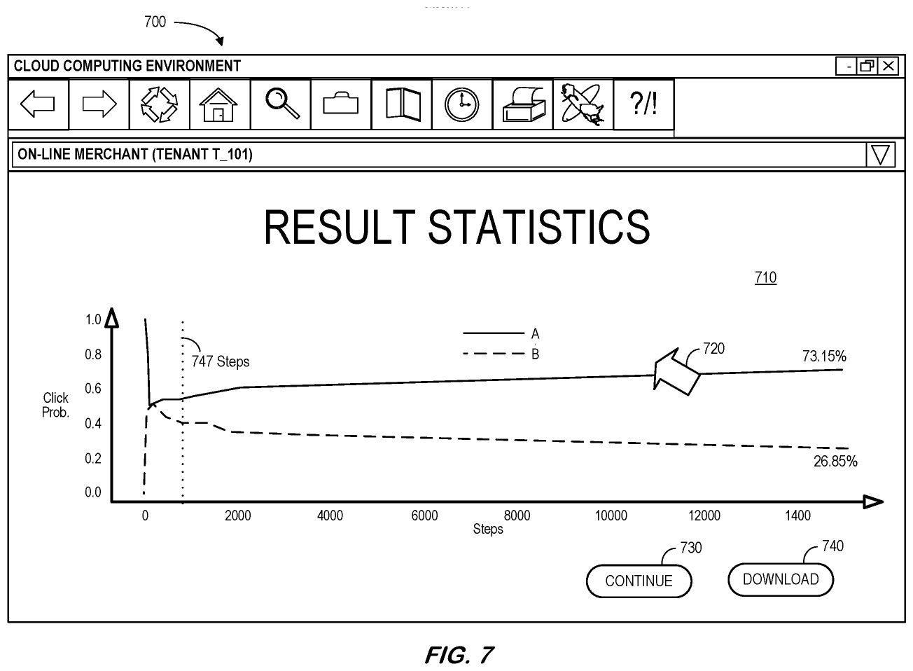

FIG. 7 is a human machine interface result statistics display 700 in accordance with some embodiments. The display 700 includes a graphical representation 710 or dashboard that might be used to present statistics that have been collected for a bandit strategy and/or A/B test (e.g., associated with a multi-tenant cloud provider). In particular, selection of an element (e.g., via a touchscreen or computer mouse pointer 720) might result in the display of a popup window that contains additional information about the test results (e.g., underlying data. The display 700 may also include a user selectable “Continue” icon 730 to continue to run trials or steps (e.g., to further refine or improve system performance) and a “Download” icon 740 to deploy a product bundle to actual customers.

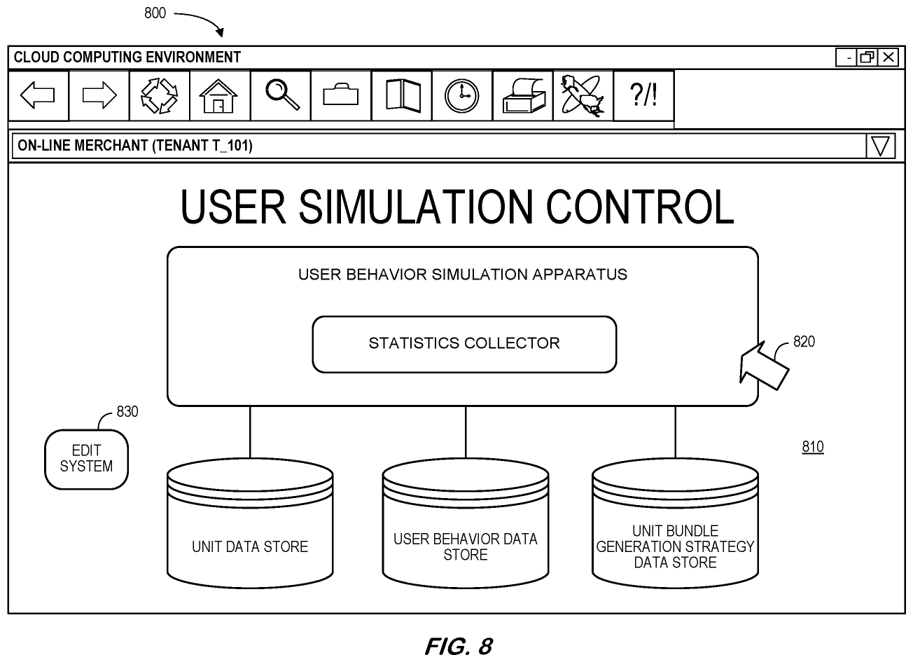

FIG. 8 is a human machine interface operator or administrator display 800 in accordance with some embodiments. The display 800 includes a graphical representation 810 or dashboard that might be used to manage or monitor a SaaS user simulation framework (e.g., associated with a multi-tenant cloud provider). In particular, selection of an element (e.g., via a touchscreen or computer mouse pointer 820) might result in the display of a popup window that contains configuration data. The display 800 may also include a user selectable “Edit System” icon 830 to request system changes (e.g., to update a user decay model, bandit strategy, etc.).

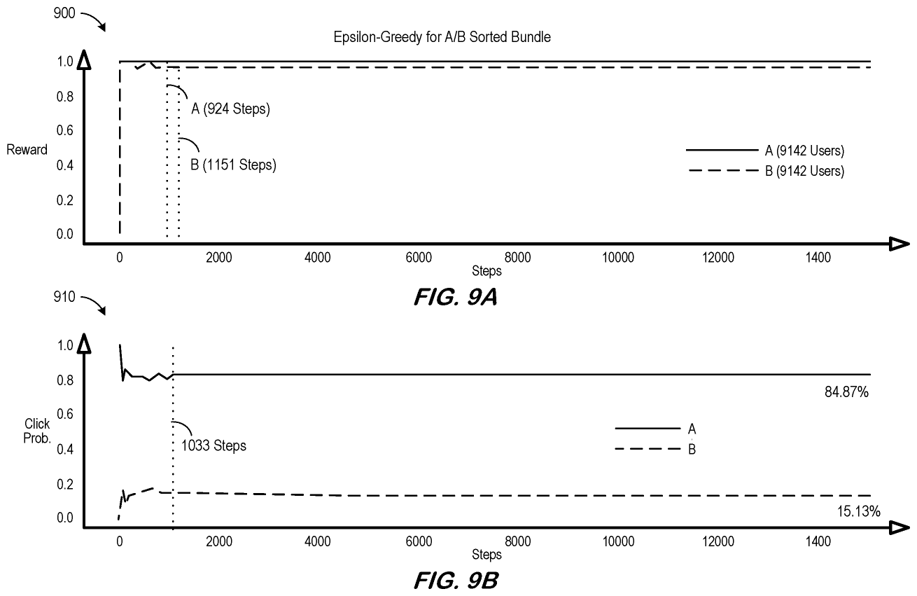

FIGS. 9A, 9B, 10A, 10B, 11A, and 11B compare various bandit strategies for one tenant in a multi-tenant computing environment. For each algorithm, two graphs are included. The first graph shows a reward probability for a treatment A/B. If a treatment A/B is recommended for target user, what is the click probability for that user (“reward”) when he or she is faced with that recommendation. Note that enough trials or steps, the reward probability for clicks may converge. The second graph shows the splitting probability for the treatment A/B. Note that, for arbitrary algorithms, they will eventually tend to recommend a treatment A/B via a fixed splitting rating. The second graph depicts how two treatments converge to a final splitting rate.

Different product bundles may need to be explored over time to learn what their payouts are, but the system simultaneously wants to exploit the most profitable bundle. This balance of exploitation (the desire to choose an action which has paid off well in the past) and exploration (the desire to try options which may produce even better results) is at the heart of multi-armed bandit algorithms. The Epsilon-Greedy algorithm balances exploitation and exploration in a simple way. It takes a parameter (“epsilon”) between 0 and 1, as the probability of exploring the options (arms) as opposed to exploiting the current best variant in the test. For example, when epsilon is set at 0.1 and a user visits a website being tested, a number between 0 and 1 is randomly drawn. If that number is greater than 0.1, then the user will be shown whichever variant (at first, version A) is performing best. If the random number is less than 0.1, then a random arm out of all available options will be chosen and provided to the user. The user's reaction is recorded (a click or no click, a sale or no sale, etc.), and the success rate of that arm is updated accordingly.

FIGS. 9A and 9B illustrate Epsilon-Greedy test results for an A/B sorted bundle according to some embodiments. For the reward probability 900, the reward probability of treatment A converges after 924 steps and the reward probability of treatment B converges after 1151 steps. As a result, Pr(A)=99.62%, Pr(B)=96.67%. For the splitting probability 910, 84.87% will be recommended to treatment A (after 1033 steps) and 15.13% will be recommended to treatment B (after 1033 steps).

A flaw in Epsilon-Greedy is that it explores at random. If there are two arms with similar rewards, a lot of exploration may be needed to learn which is better (and a high epsilon is appropriate. However, the two arms have substantially different rewards (which is not known at the start), the system might still set a high epsilon and many trials would use the less profitable option. The Softmax algorithm addresses this problem by selecting each arm in an explore phase roughly in proportion to the currently expected reward.

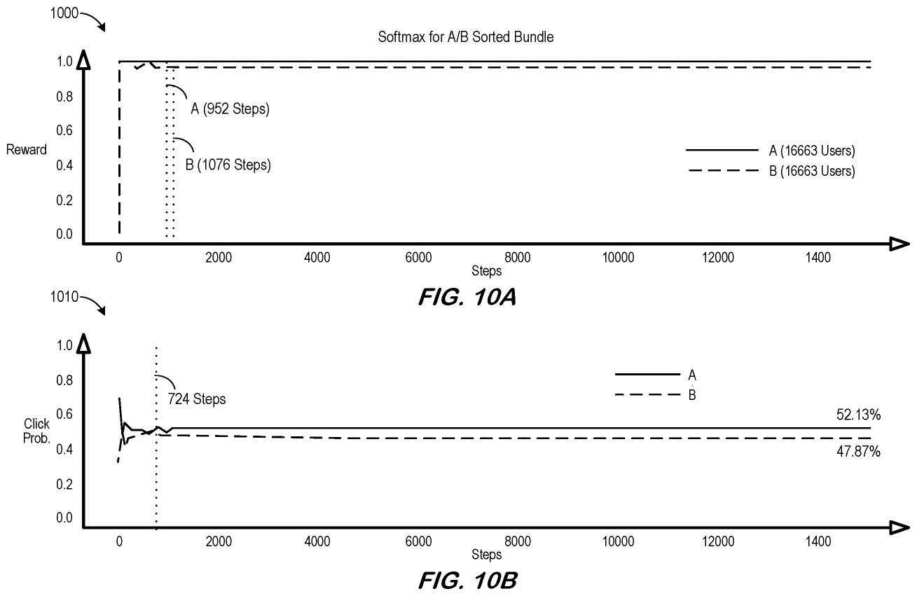

FIGS. 10A and 10B illustrate Softmax test results for an A/B sorted bundle in accordance with some embodiments. For the reward probability 1000, the reward probability of treatment A will converge after 952 steps and the reward probability of treatment B will converge after 1076 steps. As a result, Pr(A)=99.58%, Pr(B)=95.39%. For the splitting probability 1010, 52.13% will be recommended to treatment A (after 724 steps) and 47.87% will be recommended to treatment B (after 724 steps).

Although the Softmax algorithm takes into account the expected value of each arm, it is possible that a poor performing arm will initially have several successes in a row (and thus be favored by the algorithm during the exploit phase). Such an approach may under-explore arms that could have a high level of profit. The Upper Confidence Bound (“UCB”) class of bandit algorithms takes into account how much is known about each arm (encouraging the algorithm to favor those arms so that more can be learned).

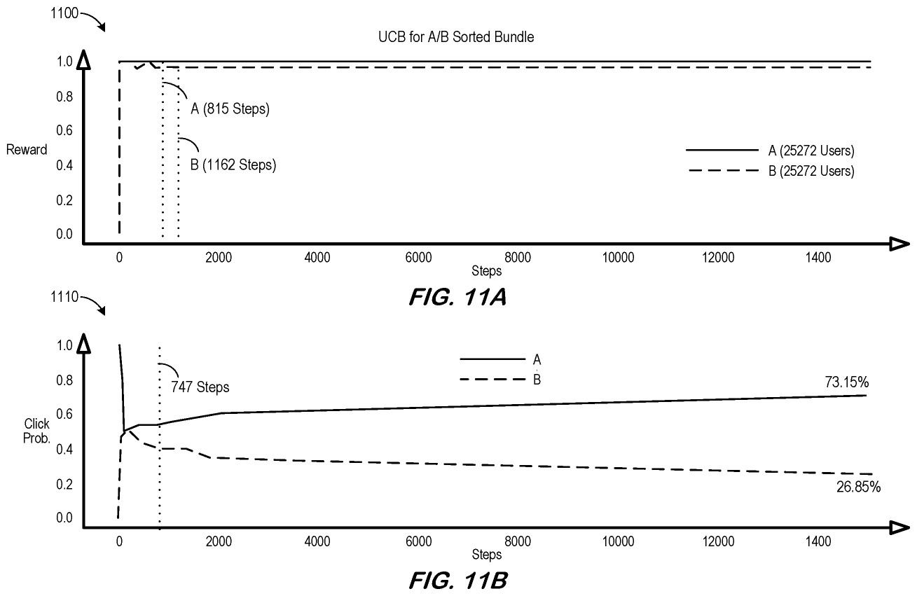

FIGS. 11A and 11B illustrate UCB test results for an A/B sorted bundle according to some embodiments. For reward probability 1100, the reward probability of treatment A will converge after 815 steps and the reward probability of treatment B will converge after 1162 steps. As a result, Pr(A)=99.64%, Pr(B)=96.90%. For the splitting probability 1110, 73.15% will be recommended to treatment A (after 747 steps) and 26.85% will be recommended to treatment B (after 747 steps).

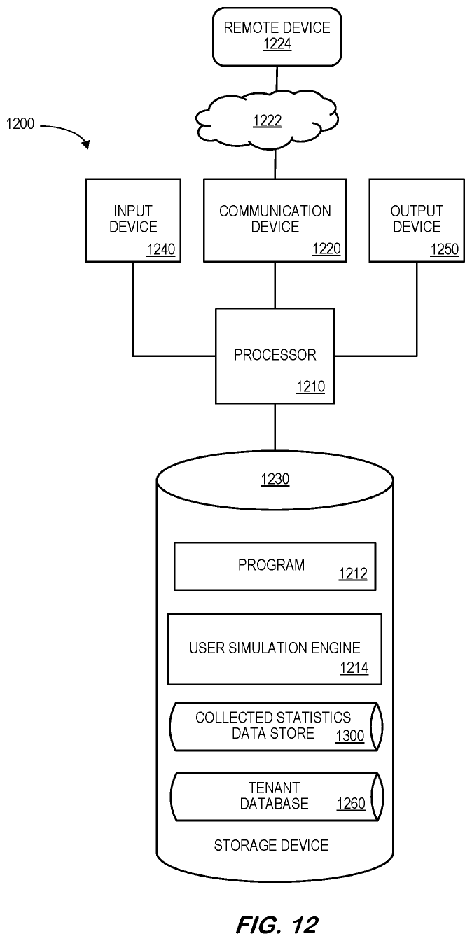

Note that the embodiments described herein may be implemented using any number of different hardware configurations. For example, FIG. 12 is a block diagram of an apparatus or platform 1200 that may be, for example, associated with the system 300 of FIG. 3 (and/or any other system described herein). The platform 1200 comprises a processor 1210, such as one or more commercially available CPUs in the form of one-chip microprocessors, coupled to a communication device 1220 configured to communicate via a communication network 1222. The communication device 1220 may be used to communicate, for example, with one or more remote devices 1224 (e.g., to report collected statistics, implement a new product bundle to actual live customers, etc.) via a communication network 1222. The platform 1200 further includes an input device 1240 (e.g., a computer mouse and/or keyboard to input data about model training and/or historic user and product information) and an output device 1250 (e.g., a computer monitor to render a display, transmit recommendations or alerts, and/or create monitoring reports). According to some embodiments, a mobile device and/or PC may be used to exchange data with the platform 1200.

The processor 1210 also communicates with a storage device 1230. The storage device 1230 can be implemented as a single database or the different components of the storage device 1230 can be distributed using multiple databases (that is, different deployment data storage options are possible). The storage device 1230 may comprise any appropriate data storage device, including combinations of magnetic storage devices (e.g., a hard disk drive), optical storage devices, mobile telephones, and/or semiconductor memory devices. The storage device 1230 stores a program 1212 and/or user simulation engine 1214 for controlling the processor 1210. The processor 1210 performs instructions of the programs 1212, 1214, and thereby operates in accordance with any of the embodiments described herein. For example, the processor 1210 may retrieve, from a unit data store, relevant unit data. The processor 1210 may also retrieve, from a user behavior data store, user behavior data (and train a user interest decay model based on the retrieved user behavior data) along with a unit bundle generation strategy model from a unit bundle generation strategy data store (and initialize control parameters of the unit bundle generation strategy model). The processor 1210 may then initialize control parameters of an A/B treatment generation strategy model and repeatedly simulate user interest in unit bundles using the relevant unit data, the user interest decay model, the unit bundle generation strategy model, and the A/B treatment generation strategy model. Based on the simulated user interest in unit bundles, statistics associated with bandit strategy results are collected by the processor 1210 and transmitted when at least one evaluation condition is satisfied.

The programs 1212, 1214 may be stored in a compressed, uncompiled and/or encrypted format. The programs 1212, 1214 may furthermore include other program elements, such as an operating system, clipboard application, a database management system, and/or device drivers used by the processor 1210 to interface with peripheral devices.

As used herein, data may be “received” by or “transmitted” to, for example: (i) the platform 1200 from another device; or (ii) a software application or module within the platform 1200 from another software application, module, or any other source.

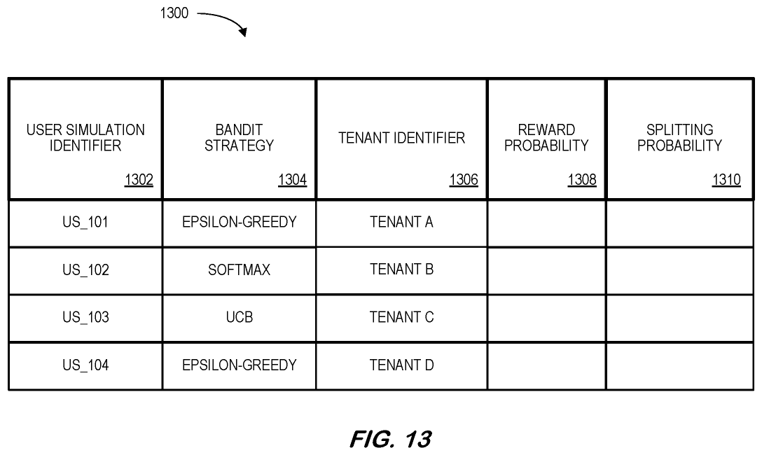

In some embodiments (such as the one shown in FIG. 12), the storage device 1230 further stores a tenant database 1260 and a collected statistics data store 1300. An example of a database that may be used for the platform 1200 will now be described in detail with respect to FIG. 13. Note that the database described herein is only one example, and additional and/or different data may be stored therein. Moreover, various databases might be split or combined in accordance with any of the embodiments described herein.

Referring to FIG. 13, a table is shown that represents the collected statistics data store 1300 that may be stored at the platform 1200 according to some embodiments. The table may include, for example, entries identifying user simulations that have been performed in a multi-tenant cloud computing environment. The table may also define fields 1302, 1304, 1306, 1308, 1310 for each of the entries. The fields 1302, 1304, 1306, 1308, 1310 may, according to some embodiments, specify: a user simulation identifier 1302, a bandit strategy 1304, a tenant identifier 1306, a reward probability 1308, and a splitting probability 1310. The collected statistics data store 1300 may be created and updated, for example, when a new tenant is added to a system, when user simulations are executed, etc.

The user simulation identifier 1302 might be a unique alphanumeric label or link that is associated with a user simulation that has been executed. The bandit strategy 1304 may indicate various multi-arm algorithms (Epsilon-Greedy, Softmax, UCB, etc.) and the tenant identifier 1306 might indicate an on-line merchant in a multi-tenant cloud computing environment. The reward probability 1308 might indicate how may users clicked on a product bundle and the splitting probability 1310 may reflect how two A/B treatments converge to a final rate.

In this way, embodiments may improve the performance of bandit strategies without needing to show units to a substantial number of real-world users. Note that one of treatment A or B may converge first and the other treatment might not converge without sufficient trial time. For convergence speed of the first treatment, UCB will be relatively faster than Softmax and Epsilon-Greedy. Moreover, the splitting probability will be converged at the same step for both treatment A and B. Embodiments may use a small delta with a sufficiently long trial series to measure if probability has converged. From a numeric calculation perspective, this might be correct. However, from a strictly mathematical perspective, it might not. That is, even after numeric convergence the values might decrease or increase in the long run. Embodiments may not only help the system simulate the whole sophisticated A/B treatment process but may also facilitate the use of a bandit strategy when demonstrating product bundles for customers.

Thus, embodiments may provide substantial improvement to the effective validation of Bandit strategies used in an on-line marketplace (less customer interaction time, more accurate tracking for convergence time point, full information about the whole interaction lifecycle, etc.). Moreover, embodiments may imitate customer interests in a natural way by introducing a decay model and allowing importing customer interests (metadata) during initialization. Embodiments may also be able to clearly track profit and/or customer behavior in the simulator (allow for a better understanding of customer behavior) and provide flexibility to introduce product features and more sophisticated probabilistic models to control customer interest in products and product bundles.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

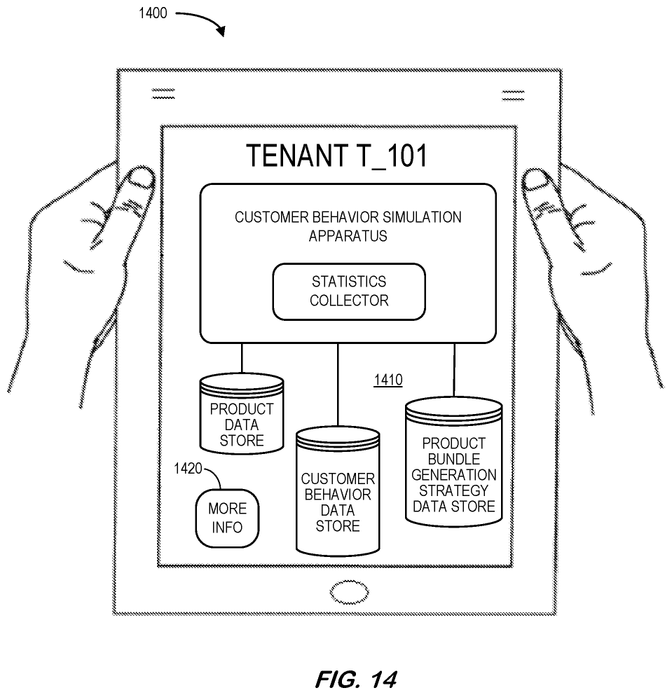

Although specific hardware and data configurations have been described herein, note that any number of other configurations may be provided in accordance with some embodiments of the present invention (e.g., some of the data associated with the databases described herein may be combined or stored in external systems). Moreover, although some embodiments are focused on particular types of bandit strategies, any of the embodiments described herein could be applied to other types of bandit strategies. Moreover, the displays shown herein are provided only as examples, and any other type of user interface could be implemented. For example, FIG. 14 shows a handheld tablet computer 1400 rendering a tenant display 1410 that may be used to view or adjust existing system framework components and/or to request additional data (e.g., via a “More Info” icon 1420).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with user behavior simulation, comprising:
a unit data store associated with a first tenant of a multi-tenant cloud computing environment;
a user behavior data store associated with the first tenant;
a unit bundle generation strategy data store associated with the first tenant; and
a user behavior simulation apparatus, coupled to the unit data store, the user behavior data store, and the unit bundle generation strategy data store, including:
a computer processor, and
a computer memory coupled to the computer processor and storing instructions that, when executed by the computer processor, cause the user behavior simulation apparatus to:
(i) retrieve, from the unit data store, relevant unit data for the first tenant,
(ii) retrieve, from the user behavior data store, user behavior data and train a user interest decay model for the first tenant based on the retrieved user behavior data,
(iii) retrieve, from the unit bundle generation strategy data store, a unit bundle generation strategy model and initialize control parameters of the unit bundle generation strategy model for the first tenant,
(iv) initialize control parameters of an AB treatment generation strategy model for the first tenant,
(v) repeatedly simulate user interest in unit bundles using the relevant unit data, the user interest decay model, the unit bundle generation strategy model, and the A/B treatment generation strategy model, said simulated user interest reducing a number of messages exchanged with real world users via a distributed communication network,
(vi) based on the simulated user interest in unit bundles, collect results associated with multi-arm strategy results for the first tenant,
(vii) transmit the collected results, via a communication port to a remote device of the first tenant, when at least one evaluation condition is satisfied, and
(viii) responsive to the transmitted results, automatically deploying product bundles for actual customers,
wherein the control parameters of the unit bundle generation strategy model are initialized differently for a second tenant of the multi-tenant cloud computing environment as compared to the first tenant.

2. The system of claim 1, wherein a unit is associated with a product bundle and a user is associated with a simulated potential customer.

3. The system of claim 2, wherein the relevant unit data, the user behavior data, the unit bundle generation strategy model, and the A/B treatment generation strategy model are associated with a tenant of a multi-tenant cloud computing environment.

4. The system of claim 2, wherein the user behavior data:
(i) product reviews, (ii) product searches, (iii) requests for product details, (iv) products placed into a virtual shopping cart, (v) product purchases, and (vi) review-reject results.

5. The system of claim 2, wherein the A/B treatment generation strategy model is associated with at least one of: (i) product splitting by category, and (ii) a campaign-based strategy.

6. The system of claim 2, wherein the user behavior simulation apparatus is associated with at least one of: (i) an Epsilon-Greedy multi-arm simulation, (ii) a Softmax multi-arm simulation, and (iii) an Upper Confidence Bound (“UCB”) multi-arm simulation.

7. The system of claim 6, wherein the evaluation condition is associated with at least one of: (i) a number of steps, (ii) reward probability convergence, (iii) a splitting probability, and (iv) a profitability goal.

8. The system of claim 7, wherein the collected results are associated with at least one of: (i) a reward convergence, and (ii) a recommendation trend of the A/B treatment generation strategy model.

9-20. (canceled)
